(19) United States
(12) Patent Application Publication
(10) Pub. No.: US 2026/0087347 A1
(43) Pub. Date: Mar. 26, 2026

(54) SEMICONDUCTOR TECHNOLOGY SPECIFIC ADAPTIVE NEURAL NETWORK

(71) Applicant: QUALCOMM Incorporated, San Diego, CA (US)

(72) Inventors: Mustafa KESKIN, San Diego, CA (US); Lindsey Makana KOSTAS, San Diego, CA (US); Andriy TEMKO, Ballincollig (IE)

(21) Appl. No.: 18/896,444

(22) Filed: Sep. 25, 2024

(51) Int. Cl. G06N 3/082

(52) U.S. Cl. CPC G06N 3/082

(57) ABSTRACT

Aspects of the disclosure are directed to implementation of an adaptive neural network operation. In accordance with one aspect, the disclosure includes adaptively pruning an adaptive neural network to generate a pruned adaptive neural network; ingesting a plurality of technology-specific model parameters used for an activation function of the pruned adaptive neural network; selecting one of the plurality of technology-specific model parameters based on an operational mode; and determining a predictive operational point for a power management integrated circuit (PMIC) using the pruned adaptive neural network and the one of the plurality of technology-specific model parameters.

### TECHNICAL FIELD

This disclosure relates generally to the field of adaptive neural networks, and, in particular, to an adaptive neural network for power management.

### BACKGROUND

Power management is an important functional capability in an information processing system. Power management aims to deliver high efficiency and reliable dc power to a plurality of loads with diverse characteristics. An adaptive power management system determines an appropriate operational point for a predictive load characteristic based on a neural network model of the plurality of loads.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides implementation of an adaptive neural network operation. Accordingly, the present disclosure discloses an apparatus including: a controller configured to generate an adaptive neural network; a selector coupled to the controller, the selector configured to select one of a plurality of technology-specific model parameters based on an operational mode; and a nonlinear module coupled to the selector, the nonlinear module configured to determine a predictive operational point for a power management integrated circuit (PMIC) using the adaptive neural network and the one of the plurality of technology-specific model parameters.

In one example, the apparatus further includes a multiplexer coupled to the selector and the nonlinear module, the multiplexer configured to ingest the plurality of technology-specific model parameters used for an activation function of the pruned adaptive neural network. In one example, the controller is further configured to select an adjustable time window to define a size of an input to the adaptive neural network. In one example, the adjustable time window is based on an acceleration or a deceleration of an input signal and an input signal slope. In one example, the controller is further configured to set a clock for the adaptive neural network.

Another aspect of the disclosure provides an apparatus including: means for adaptively pruning an adaptive neural network to generate a pruned adaptive neural network; means for ingesting a plurality of model parameters used for an activation function of the pruned adaptive neural network; means for selecting one of the plurality of c model parameters based on an operational mode; and means for determining a predictive operational point for a power management integrated circuit (PMIC) using the pruned adaptive neural network and the one of the plurality of model parameters.

In one example, the plurality of model parameters is a plurality of technology-specific model parameters which is a plurality of semiconductor current-voltage characteristics, a plurality of semiconductor capacitance-voltage characteristics or a plurality of sensor characteristics. In one example, a reduced quantity of layers for the pruned adaptive neural network is governed by one or more application latency requirements and one or more application accuracy requirements, and wherein a pruning amount is based on a clock rate.

Another aspect of the disclosure provides a method including: generating an adaptive neural network; ingesting a plurality of technology-specific model parameters used for an activation function of the adaptive neural network; selecting one of the plurality of technology-specific model parameters based on an operational mode; and determining a predictive operational point for a power management integrated circuit (PMIC) using the adaptive neural network and the one of the plurality of technology-specific model parameters.

In one example, the method further includes adaptively pruning the adaptive neural network to generate a pruned adaptive neural network. In one example, the method further includes selecting an adjustable time window to define a size of an input to the adaptive neural network. In one example, the adjustable time window is based on an acceleration or a deceleration of an input signal and an input signal slope.

In one example, the method further includes configuring the adaptive neural network. In one example, the method further includes configuring the adaptive neural network with a first clock rate. In one example, the method further includes configuring the pruned adaptive neural network with a second clock rate, wherein the second clock rate is greater than the first clock rate.

In one example, the reduced quantity of layers is governed by one or more application latency requirements and one or more application accuracy requirements. In one example, the activation function is in a last layer of the pruned adaptive neural network. In one example, the plurality of technology-specific model parameters is a plurality of semiconductor current-voltage characteristics. In one example, the plurality of technology-specific model parameters is a plurality of semiconductor capacitance-voltage characteristics. In one example, the plurality of technology-specific model parameters is a plurality of sensor characteristics.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example multi-chip modem system.

FIG. 2 illustrates an example system on a chip (SOC) with a plurality of functional chips.

FIG. 3 illustrates a first example adaptive neural network (NN).

FIG. 4 illustrates an example graph of a plurality of CMOS current-voltage characteristics.

FIG. 5 illustrates an example graph of silicon germanium (SiGe) current-voltage characteristic.

FIG. 6 illustrates a second example adaptive neural network (NN).

FIG. 7 illustrates a first example graph of capacitance-voltage characteristic.

FIG. 8 illustrates an example graph of a plurality of capacitance-voltage characteristics.

FIG. 9 illustrates a third example adaptive neural network (NN).

FIG. 10 illustrates a fourth example adaptive neural network (NN).

FIG. 11 illustrates an example flow diagram to implement adaptive neural network operation.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In an information processing system, multiple chip technologies may be integrated onto a common platform (e.g., a mobile phone) to provide a diversity of user services. One key aspect of system design is optimal dc power regulation and distribution provided by a device such as a power management integrated circuit (PMIC). The PMIC is responsible for providing a plurality of regulated (i.e., stable) secondary voltages to various loads. However, because of the diversity of load types, the PMIC may need an adaptive capability to manage the plurality of regulated secondary voltages.

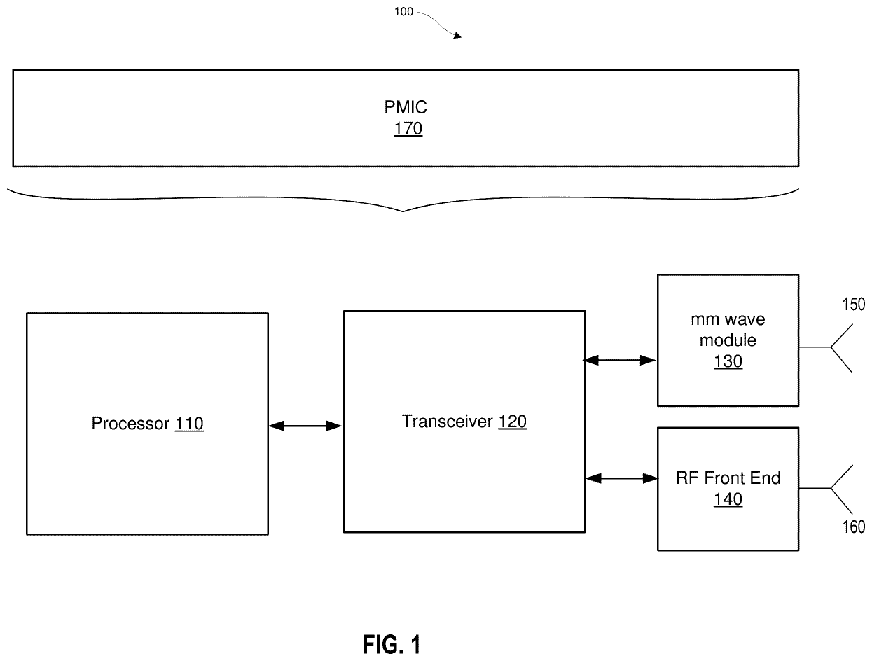

FIG. 1 illustrates an example multi-chip modem system 100. In one example, the multi-chip modem system 100 includes a processor 110, a transceiver 120, a millimeter (mm) wave module 130 coupled to a mm wave antenna 150 and a radio frequency front end (RFFE) 140 coupled to an RF antenna 160. In one example, a PMIC 170 manages dc power regulation and distribution for the multi-chip modem system 100.

In one example, a modern electronics system, such as the multi-chip modem system 100, incorporates a broad diversity of electronics technologies. For example, the mm wave module 130 and the RFFE 140 may incorporate gallium arsenide (GaAs) technology, silicon on insulator (SOI) technology, etc. For example, the PMIC may incorporate gallium nitride (GaN) technology, or power complementary metal oxide semiconductor (CMOS) technology. The transducers may incorporate microelectromechanical systems (MEMS). A memory or a system on a chip (SOC) may incorporate CMOS technology (e.g., 7 nm line width, 5 nm line width, etc.). Power circuits may incorporate power MOS. RF applications may incorporate bipolar junction transistor (BJT) or bipolar semiconductors, etc.

In one example, the PMIC does not intrinsically account for electronics technology in its load. For example, the load may be manufactured with a different process, have a different operating point, or exhibit different process voltage temperature (PVT) characteristics compared to other loads. A plurality of loads may have a plurality of load characteristics. In one example, a SOC has a plurality of load specifications but no control over load characteristics.

In one example, the PMIC needs to monitor current and voltage operating points of its loads to determine a current operational state. In some cases, extra chipsets or additional firmware may be used to perform operational state determination. In one example, the SOC may be aware of a current operational mode and may integrate a priori knowledge of load characteristics in each subsystem. Hence, an efficient PMIC operation may occur with predictive load estimation capability based on this knowledge.

In one example, an adaptive neural network (NN) (e.g., tracker) may be used in an information processing system to estimate load characteristics and power load demand of a plurality of loads. In one example, the adaptive NN may provide a characteristic tracking capability using an operational mode or subsystem as parameters.

In one example, the adaptive NN may include an adaptive last layer with a technology-specific activation library for power load estimation. For example, if a user listens to music, the adaptive NN automatically transitions to a CMOS-based last layer. For example, if the user executes uplink data transmission, the adaptive NN automatically transitions to a GaAs-based last layer. For example, if the user executes gaming applications, the adaptive NN automatically transitions to CMOS-specific or GPU-based activations for power load estimation and thermal event estimation.

In one example, the adaptive NN may include configurable NN layers with a subsystem in use. For example, if a subsystem throughput is increased, the adaptive NN may be trimmed to enable a faster response time. For example, the subsystem may provide its current clock rate or signal bandwidth and the adaptive NN may be updated accordingly.

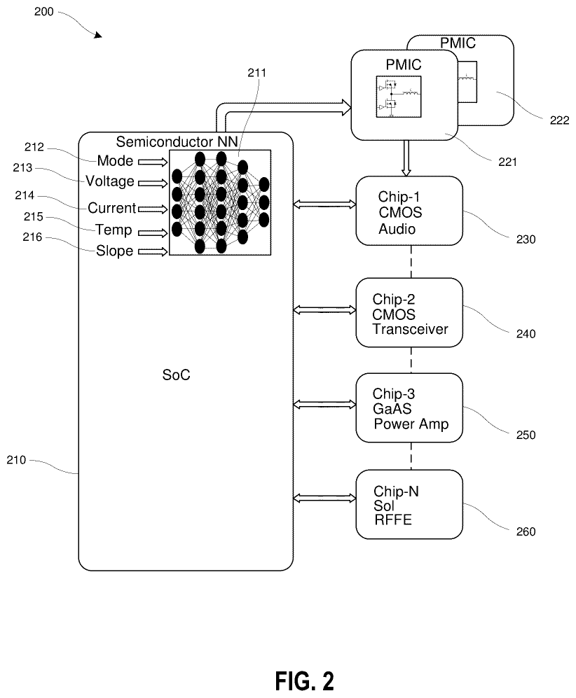

FIG. 2 illustrates an example system on a chip (SOC) with a plurality of functional chips 200. In one example, a SOC 210 includes an adaptive NN 211 with a node input 212, a voltage input 213, a current input 214, a temperature input 215, a slope input 216, etc. In one example, the SOC 210 obtains regulated dc power from a first PMIC 221 and a second PMIC 222.

In one example, the SOC 210 is connected to a CMOS-based audio chip 230, a CMOS-based transceiver 240, a GaAs-based power amplifier 250, and a SoI-based RF front end (RFFE) 260. In one example, the adaptive NN 211 provides a future (i.e., adaptive time-window based) power load demand to the first PMIC 221 and the second PMIC 222. In one example, the adaptive NN 211 may include a semiconductor technology type activation function selection. In one example, the adaptive NN 211 may reduce dc power at the first PMIC 221 and the second PMIC 222 with minimized power supply headroom. For example, thermal information may improve power load demand estimation. In one example, the adaptive NN may be part of the SOC 210 or be part of the first PMIC 221 or the second PMIC 222.

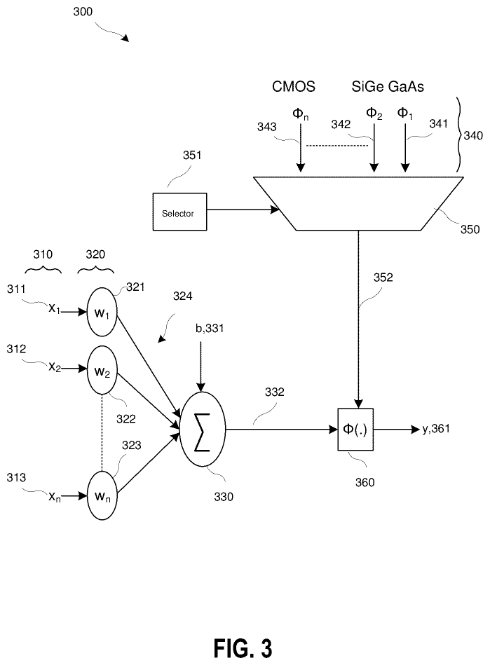

FIG. 3 illustrates a first example adaptive neural network (NN) 300. In one example, the first adaptive NN 300 may be used for power dissipation estimation with a plurality of activation functions based on a plurality of current-voltage (I-V) characteristics. In one example, the first adaptive NN 300 is implemented in a system on a chip (SOC).

In one example, the first adaptive NN 300 includes a plurality of NN inputs 310 with a first NN input X1 311, a second NN input X2 312, and so on, until an nth NN input Xn 313. In one example, the plurality of NN inputs 310 is scaled by a plurality of NN weights 320 with a first NN weight w1 321, a second NN weight w2 322, and so on, until an nth NN weight wn 323 to produce a plurality of scaled NN inputs 324. In one example, each scaled NN input of the plurality of scaled NN inputs 324 is produced by multiplying each NN input of the plurality of NN inputs 310 with each NN weight of the plurality of NN weights 320. In one example, the plurality of scaled NN inputs 324 is sent to a summer 330 for summation and addition of a bias offset b 331 to produce a composite input 332.

In one example, a plurality of activation functions 340 including a first activation function φ1 341, a second activation function φ2 342, and so on, until an nth activation function φn 343 serves as input to a multiplexer 350. In one example, one activation function of the plurality of activation functions 340 is selected by a selector 351. For example, the selection may be based on an operational mode of the SOC.

In one example, each activation function of the plurality of activation functions is based on a current-voltage (I-V) characteristic of a particular semiconductor technology. For example, the particular semiconductor technology may be gallium arsenide (GaAs), silicon germanium (SiGe), complementary metal oxide semiconductor (CMOS), etc.

In one example, depending on a selector state of the selector 351, a selected activation function 352 is selected from the plurality of activation functions 340 and is sent to a nonlinear module 360 along with the composite input 332. In one example, the nonlinear module 360 produces an evaluated output function y 361. For example, the evaluated output function y 361 is produced by computing the selected activation function 352 with the composite input 332.

In one example, the first adaptive NN 300 may be the final stage of a multi-stage neural network. For example, the first adaptive NN 300 maps process information directly to output values. For example, a power or a gain of a particular operational mode is a target for the first adaptive NN 300.

In one example, based on the operational mode, the nonlinear module 360 of FIG. 3 is used to map dc power demand rapidly to a particular semiconductor technology. In one example, the first adaptive NN 300 of FIG. 3 is part of a last layer of a multi-layer NN where the last layer is only layer which is adapted to a semiconductor technology type.

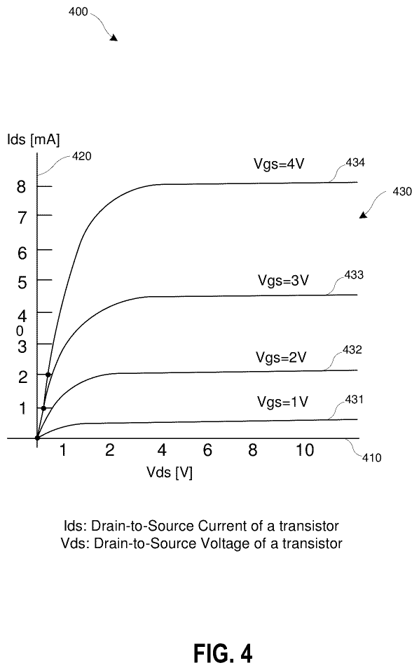

FIG. 4 illustrates an example graph 400 of a plurality of CMOS current-voltage characteristics. The plurality of CMOS current-voltage characteristics graph 400 includes a drain-source voltage (Vds) axis 410 as a horizontal axis with volt units and a drain-source current (Ids) axis 420 as a vertical axis with milliampere (mA) units. In one example, the plurality of CMOS current-voltage characteristics graph 400 includes a first drain-source current curve 431 with a gate-source voltage (Vgs) of 1 v. In one example, the plurality of CMOS current-voltage characteristics graph 400 includes a second drain-source current curve 432 with a gate-source voltage (Vgs) of 2 v. In one example, the plurality of CMOS current-voltage characteristics graph 400 includes a third drain-source current curve 433 with a gate-source voltage (Vgs) of 3 v. In one example, the plurality of CMOS current-voltage characteristics graph 400 includes a fourth drain-source current curve 434 with a gate-source voltage (Vgs) of 4 v. For example, the first drain-source current curve 431 is a nonlinear curve.

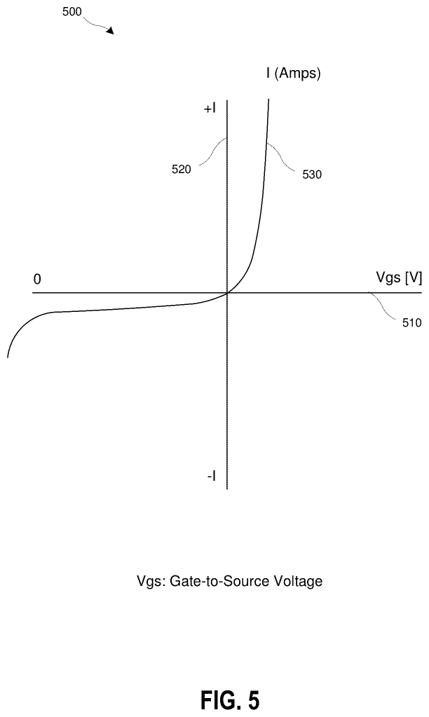

FIG. 5 illustrates an example graph 500 of silicon germanium (SiGe) current-voltage characteristic. The SiGe current-voltage characteristic graph 500 includes a gate-source voltage (Vgs) axis 510 as a horizontal axis with volt units and a current (I) axis 520 as a vertical axis with ampere units. In one example, a current curve 530 is shown as a function of gate-source voltage (Vgs). For example, the current curve 530 is a nonlinear curve.

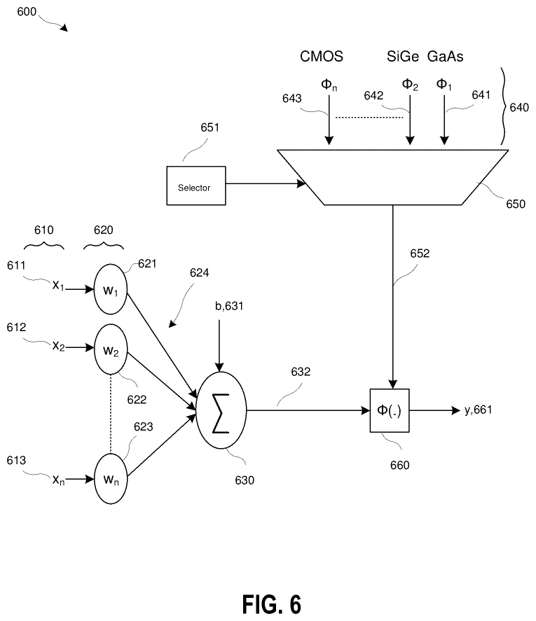

FIG. 6 illustrates a second example adaptive neural network (NN) 600. In one example, the second adaptive NN 600 may be used for power dissipation estimation with a plurality of activation functions based on a plurality of capacitance-voltage (C-V) characteristics. In one example, the second adaptive NN 600 is implemented in a system on a chip (SOC).

In one example, the second adaptive NN 600 includes a plurality of NN inputs 610 with a first NN input X1 611, a second NN input X2 612, and so on, until an nth NN input Xn 613. In one example, the plurality of NN inputs 610 is scaled by a plurality of NN weights 620 with a first NN weight w1 621, a second NN weight w2 622, and so on, until an nth NN weight wn 623 to produce a plurality of scaled NN inputs 624. In one example, each scaled NN input of the plurality of scaled NN inputs 624 is produced by multiplying each NN input of the plurality of NN inputs 610 with each NN weight of the plurality of NN weights 620. In one example, the plurality of scaled NN inputs 624 is sent to a summer 630 for summation and addition of a bias offset b 631 to produce a composite input 632.

In one example, a plurality of activation functions 640 including a first activation function φ1 641, a second activation function φ2 642, and so on, until an nth activation function φn 643 serves as input to a multiplexer 650. In one example, one activation function of the plurality of activation functions 640 is selected by a selector 651. For example, the selection may be based on an operational mode of the SOC.

In one example, each activation function of the plurality of activation functions is based on a capacitance-voltage (C-V) characteristic of a particular semiconductor technology. For example, the particular semiconductor technology may be gallium arsenide (GaAs), silicon germanium (SiGe), complementary metal oxide semiconductor (CMOS), etc.

In one example, depending on a selector state of the selector 651, a selected activation function 652 is selected from the plurality of activation functions 640 and is sent to a nonlinear module 660 along with the composite input 632. In one example, the nonlinear module 660 produces an evaluated output function y 661. For example, the evaluated output function y 661 is produced by computing the selected activation function 652 with the composite input 632.

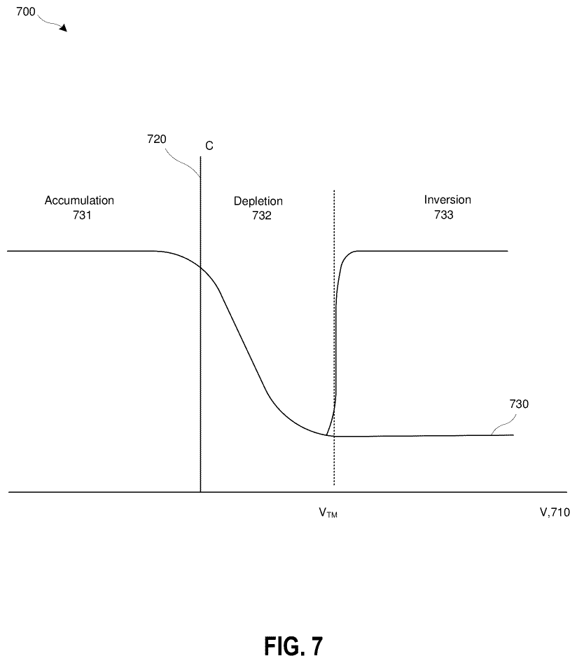

FIG. 7 illustrates a first example graph 700 of capacitance-voltage characteristic. The first capacitance-voltage characteristic graph 700 includes a voltage (V) axis 710 as a horizontal axis with volt units and a capacitance (C) axis 720 as a vertical axis with farad units. In one example, a capacitance curve 730 is shown as a function of voltage (V) over three operational regimes. For example, the three operational regimes include an accumulation regime 731, a depletion regime 732 and an inversion regime 733. For example, the depletion regime 732 and the inversion regime 733 are demarcated by a threshold voltage Vth 711. For example, the capacitance curve 730 is a nonlinear curve.

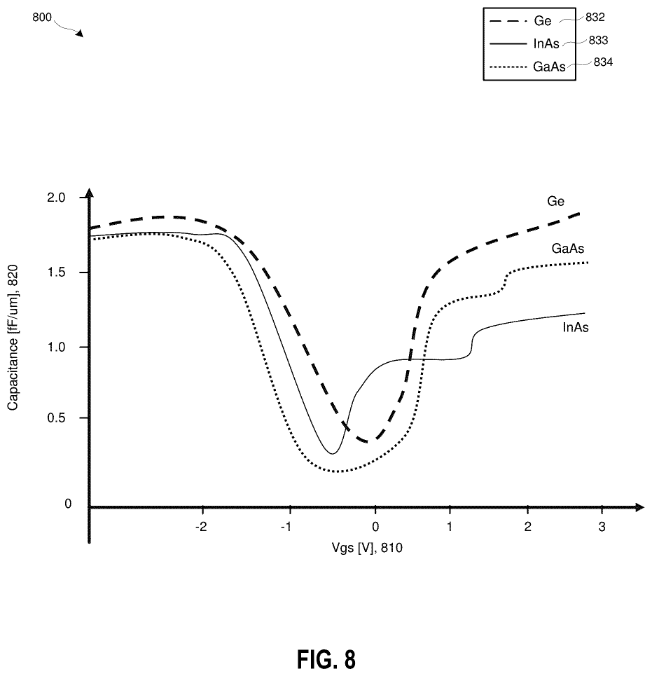

FIG. 8 illustrates an example graph 800 of a plurality of capacitance-voltage characteristics. The plurality of capacitance-voltage characteristics graph 800 includes a gate-source voltage (Vgs) axis 810 as a horizontal axis with volt units and a distributed capacitance (dC/dV) axis 820 as a vertical axis with femtofarad per micrometer (fF/μm) units. In one example, the plurality of capacitance-voltage characteristics graph 800 includes a first distributed capacitance curve 832 for germanium (Ge). In one example, the plurality of capacitance-voltage characteristics graph 800 includes a second distributed capacitance curve 833 for indium arsenide (InAs). In one example, the plurality of capacitance-voltage characteristics graph 800 includes a third distributed capacitance curve 834 for gallium arsenide (GaAs). As shown, the curves shown in the example graph 800 are all nonlinear curves.

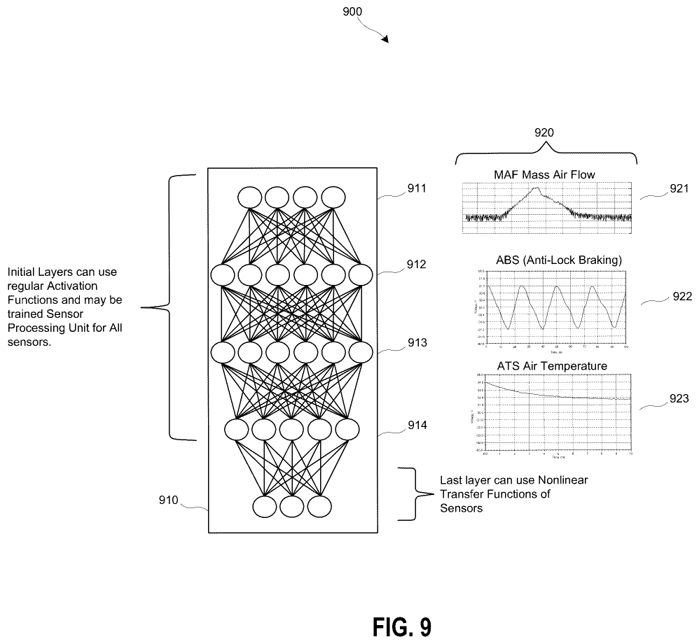

FIG. 9 illustrates a third example adaptive neural network (NN) 900. In one example, the third adaptive NN 900 may be used for power dissipation estimation with a plurality of activation functions based on a plurality of sensor characteristics. In one example, the third adaptive NN 900 is implemented in a system on a chip (SOC).

In one example, the third adaptive NN 900 includes a multi-stage neural network 910 with a first layer 911, a second layer 912, a third layer 913 and a fourth layer 914. In one example, the fourth layer 914 is a last layer which may use a plurality of nonlinear transfer functions of sensor inputs for a plurality of sensor types. In one example, the initial layers (i.e., the first layer 911, the second layer 912 and the third layer 913) of the third adaptive NN 900 may use regular activation functions and may be trained using a sensor processing unit for the plurality of sensor types.

In one example, a plurality of sensor data 920 may be used as an input of the third adaptive NN 900. For example, the plurality of sensor data 920 may include a mass air flow data 921, an anti-lock braking (ABS) data 922, an air temperature sensor (ATS) data 923, etc.

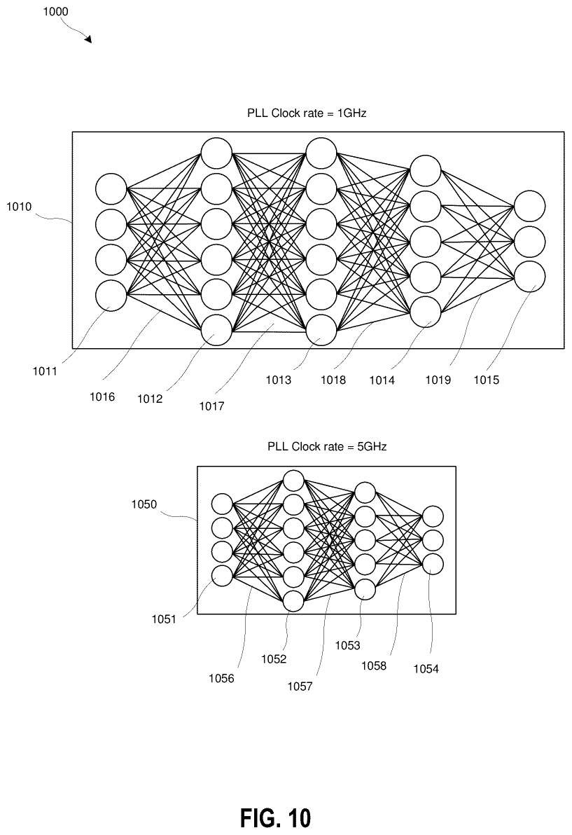

FIG. 10 illustrates a fourth example adaptive neural network (NN) 1000. In one example, the fourth adaptive NN 1000 has a first configuration 1010 and a second configuration 1050. In one example, the fourth adaptive NN 1000 may be transitioned from the first configuration 1010 to the second configuration 1050 depending on application needs. In one example, improved accuracy may be attained with a higher quantity of layers, but also with increased latency (i.e., computational delay). That is, accuracy and latency may be trade parameters in a given application.

For example, the first configuration 1010 may have a higher quantity of layers than the second configuration 1050. For example, the first configuration 1010 and the second configuration 1050 may operate at different clock rates. For example, the clock rate may be adjusted along with computational complexity (i.e., quantity of layers). For example, the first configuration 1010 may operate at a lower clock rate (e.g., 1 GHz) than the second configuration 1050 (e.g., 5 GHz). In one example, the quantity of layers and the clock rate may be configurable based on a particular application need. For example, a gaming application which is very sensitive to latency (e.g., for rapid predictive capability) may configure the fourth adaptive NN 1000 for a higher clock frequency and a lower quantity of layers. For example, the configuration for a lower quantity of layers may be attained by adaptive pruning, that is, removal of one or more layers from the fourth adaptive NN 1000. In one example, an adjustable time window may be selected based an acceleration or deceleration of an input signal and an input signal slope.

In one example, the first configuration 1010 is a five-layer NN with a first layer 1011, a second layer 1012, a third layer 1013, a fourth layer 1014 and a fifth layer 1015. For example, each layer includes a plurality of nodes. In one example, adjacent layers are interconnected with a mesh connection. In one example, a first mesh connection 1016 interconnects the first layer 1011 with the second layer 1012. In one example, a second mesh connection 1017 interconnects the second layer 1012 with the third layer 1013. In one example, a third mesh connection 1018 interconnects the third layer 1013 with the fourth layer 1014. In one example, a fourth mesh connection 1019 interconnects the fourth layer 1014 with the fifth layer 1015.

In one example, the second configuration 1050 is a four-layer NN with a first layer 1051, a second layer 1052, a third layer 1053 and a fourth layer 1054. For example, each layer includes a plurality of nodes. In one example, adjacent layers are interconnected with a mesh connection. In one example, a first mesh connection 1056 interconnects the first layer 1051 with the second layer 1052. In one example, a second mesh connection 1057 interconnects the second layer 1052 with the third layer 1053. In one example, a third mesh connection 1058 interconnects the third layer 1053 with the fourth layer 1054.

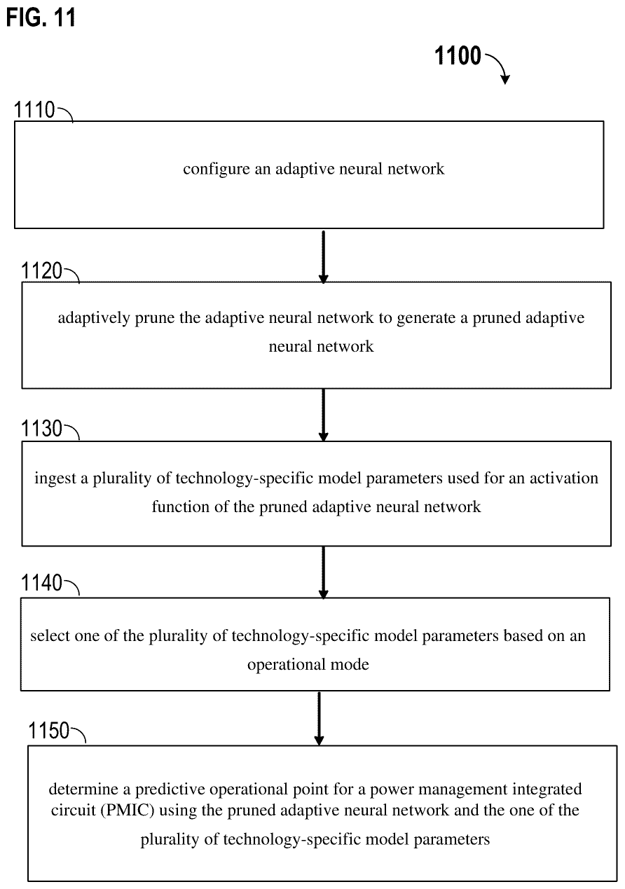

FIG. 11 illustrates an example flow diagram 1100 to implement adaptive neural network operation. In block 1110, configure an adaptive neural network. In one example, an adaptive neural network is configured. In one example, the initial adaptive neural network is configured with a first plurality of layers. In one example, the first plurality of layers includes N layers, where N is an integer greater than unity. In one example, each layer of the first plurality of layers includes a plurality of nodes and a mesh connection to connect with another layer of the first plurality of layers. In one example, the plurality of nodes includes a plurality of weights. In one example, the initial adaptive neural network is configured with a first clock rate. In one example, the initial adaptive neural network is configured with an initial quantization precision (i.e., quantity of bits per node). In one example, the step of block 1110 is performed by a controller (not shown). In one example, the step of block 1110 is performed by a processing engine, a microprocessor, a microcontroller, a central processing unit (CPU) or a display processing unit (DPU).

In block 1120, adaptively prune the adaptive neural network to generate a pruned adaptive neural network with a reduced quantity of layers. In one example, the adaptive neural network is adaptively pruned to generate a pruned adaptive neural network with a reduced quantity of layers. In one example, adaptively pruning results in the reduced quantity of layers relative to the first plurality of layers. In one example, the reduced quantity of layers is governed by application latency requirements and application accuracy requirements. In one example, the reduced quantity of layers is an integer less than N. In one example, the pruned adaptive neural network is configured with a second clock rate greater than the first clock rate. In one example, the second clock rate is governed by application latency requirements. In one example, the pruned adaptive neural network is configured with a different quantization precision than the initial quantization precision. In one example, the different quantization precision is based on application accuracy requirements. In one example, the step of block 1120 is performed by a controller (not shown). In one example, the step of block 1120 is performed by a processing engine, a microprocessor, a microcontroller, a central processing unit (CPU) or a display processing unit (DPU).

In block 1130, ingest a plurality of technology-specific model parameters used for an activation function of the pruned adaptive neural network. In one example, a plurality of technology-specific model parameters used for an activation function of the pruned adaptive neural network is ingest. In one example, the activation function is in a last layer of the pruned adaptive neural network. In one example, the plurality of technology-specific model parameters is a plurality of semiconductor current-voltage characteristics. For example, the plurality of semiconductor current-voltage characteristics is a plurality of CMOS current-voltage characteristics. For example, the plurality of semiconductor current-voltage characteristics is a plurality of SiGe current-voltage characteristics. For example, the plurality of semiconductor current-voltage characteristics is a plurality of GaAs current-voltage characteristics. In one example, the step of block 1130 is performed by a multiplexer or a selector.

In one example, the plurality of technology-specific model parameters is a plurality of semiconductor capacitance-voltage characteristics. For example, the plurality of semiconductor capacitance-voltage characteristics is a plurality of CMOS capacitance-voltage characteristics. For example, the plurality of semiconductor capacitance-voltage characteristics is a plurality of SiGe capacitance-voltage characteristics. For example, the plurality of semiconductor capacitance-voltage characteristics is a plurality of GaAs capacitance-voltage characteristics.

In one example, the plurality of technology-specific model parameters is a plurality of sensor characteristics. For example, the plurality of sensor characteristics includes sensor data for air flow, anti-lock braking (ABS), air temperature, etc.

In block 1140, select one of the plurality of technology-specific model parameters based on an operational mode. In one example, one of the plurality of technology-specific model parameters is selected based on an operational mode. In one example, the operational mode is determined by a user application (e.g., audio podcast, music delivery, data transport, gaming, etc.). In one example, the one of the plurality of technology-specific model parameters is selected for an adjustable time window. In one example, the adjustable time window is may be based on an acceleration or deceleration of an input signal and an input signal slope. In one example, the operational mode is a receive mode, a transmit mode, a passive mode, etc. In one example, the step of block 1140 is performed by a selector, a processing engine, a microprocessor, a microcontroller, a central processing unit (CPU) or a display processing unit (DPU).

In block 1150, determine a predictive operational point for a power management integrated circuit (PMIC) using the pruned adaptive neural network and the one of the plurality of technology-specific model parameters. In one example, a predictive operational point is determined for a power management integrated circuit (PMIC) using the pruned adaptive neural network and the one of the plurality of technology-specific model parameters. In one example, the predictive operational point is determined with knowledge of a current operational point. In one example, the predictive operational point is a predictive power or gain for the operational mode and user application. In one example, the step of block 1150 is performed by a nonlinear module or an activation function module.

In one aspect, one or more of the steps for implementation of an adaptive neural network operation in FIG. 11 may be executed by one or more processors which may include hardware, software, firmware, etc. The one or more processors, for example, may be used to execute software or firmware needed to perform the steps in the flow diagram of FIG. 11. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration. ” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for. ”

One skilled in the art would understand that various features of different embodiments may be combined or modified and still be within the spirit and scope of the present disclosure.

What is claimed is:

1. An apparatus comprising:
a controller configured to generate an adaptive neural network;
a selector coupled to the controller, the selector configured to select one of a plurality of technology-specific model parameters based on an operational mode; and
a nonlinear module coupled to the selector, the nonlinear module configured to determine a predictive operational point for a power management integrated circuit (PMIC) using the adaptive neural network and the one of the plurality of technology-specific model parameters.

2. The apparatus of claim 1, further comprising a multiplexer coupled to the selector and the nonlinear module, the multiplexer configured to ingest the plurality of technology-specific model parameters used for an activation function of the adaptive neural network.

3. The apparatus of claim 2, wherein the controller is further configured to select an adjustable time window to define a size of an input to the adaptive neural network.

4. The apparatus of claim 3 wherein the adjustable time window is based on an acceleration or a deceleration of an input signal and an input signal slope.

5. The apparatus of claim 4, wherein the controller is further configured to set a clock for the adaptive neural network.

6. An apparatus comprising:
means for adaptively pruning an adaptive neural network to generate a pruned adaptive neural network;
means for ingesting a plurality of model parameters used for an activation function of the pruned adaptive neural network;
means for selecting one of the plurality of model parameters based on an operational mode; and
means for determining a predictive operational point for a power management integrated circuit (PMIC) using the pruned adaptive neural network and the one of the plurality of model parameters.

7. The apparatus of claim 6, wherein the plurality of model parameters is a plurality of technology-specific model parameters which is a plurality of semiconductor current-voltage characteristics, a plurality of semiconductor capacitance-voltage characteristics or a plurality of sensor characteristics.

8. The apparatus of claim 7, wherein a reduced quantity of layers for the pruned adaptive neural network is governed by one or more application latency requirements and one or more application accuracy requirements, and wherein a pruning amount is based on a clock rate.

9. A method comprising:
generating an adaptive neural network;
ingesting a plurality of technology-specific model parameters used for an activation function of the adaptive neural network;
selecting one of the plurality of technology-specific model parameters based on an operational mode; and
determining a predictive operational point for a power management integrated circuit (PMIC) using the adaptive neural network and the one of the plurality of technology-specific model parameters.

10. The method of claim 9, further comprising adaptively pruning the adaptive neural network to generate a pruned adaptive neural network.

11. The method of claim 10, further comprising selecting an adjustable time window to define a size of an input to the adaptive neural network.

12. The method of claim 11 wherein the adjustable time window is based on an acceleration or a deceleration of an input signal and an input signal slope.

13. The method of claim 10, further comprising configuring the adaptive neural network.

14. The method of claim 13, further comprising configuring the adaptive neural network with a first clock rate.

15. The method of claim 14, further comprising configuring the pruned adaptive neural network with a second clock rate, wherein the second clock rate is greater than the first clock rate.

16. The method of claim 13, wherein the reduced quantity of layers is governed by one or more application latency requirements and one or more application accuracy requirements.

17. The method of claim 16, wherein the activation function is in a last layer of the pruned adaptive neural network.

18. The method of claim 17, wherein the plurality of technology-specific model parameters is a plurality of semiconductor current-voltage characteristics.

19. The method of claim 17, wherein the plurality of technology-specific model parameters is a plurality of semiconductor capacitance-voltage characteristics.

20. The method of claim 16, wherein the plurality of technology-specific model parameters is a plurality of sensor characteristics.
